(19) United States
(12) Patent Application Publication
(10) Pub. No.: US 2026/0072734 A1
(43) Pub. Date: Mar. 12, 2026

(54) SCHEDULING METHOD AND DEVICE FOR CLOUD NATIVE ORCHESTRATION AND SCHEDULING SYSTEM, AND STORAGE MEDIUM

(71) Applicant: Beijing Volcano Engine Technology Co., Ltd., Beijing (CN)

(72) Inventors: Xinyi SONG, Beijing (CN); Bing LI, Beijing (CN); Yuquan REN, Beijing (CN); Caixue LIN, Los Angeles, CA (US); Wu XIANG, Beijing (CN)

(21) Appl. No.: 19/291,355

(22) Filed: Aug. 5, 2025

(30) Foreign Application Priority Data
Sep. 12, 2024 (CN) 202411281893.1

(51) Int. Cl. G06F 9/48; G06F 9/50

(52) U.S. Cl. CPC G06F 9/4881; G06F 9/5083

(57) ABSTRACT

Embodiments of the present disclosure provide a scheduling method and device for a cloud native orchestration and scheduling system and a storage medium. A target judgment rule plugin is determined from multiple preset judgment rule plugins included in a preset judgment rule plugin set and loaded into a scheduler of the cloud native orchestration and scheduling system; whether any instance on any node in the cloud native orchestration and scheduling system is allowed to be preempted by a to-be-deployed instance is sequentially judged by using the target judgment rule plugin for the to-be-deployed instance; a candidate to-be-preempted instance on a candidate to-be-preempted node is determined; candidate to-be-preempted nodes are sorted by using a preset comparison plugin in the scheduler to determine a target to-be-preempted node, and the to-be-deployed instance is controlled to preempt the candidate to-be-preempted instance on the target to-be-preempted node.

### CROSS-REFERENCE TO RELATED APPLICATION(S)

This application claims priority to Chinese Patent Application No. CN 202411281893.1, filed on Sep. 12, 2024, the disclosure of which is incorporated herein by reference in its entirety.

### FIELD

Embodiments of the present disclosure relate to the technical field of computer and network communication, and in particular, to a scheduling method and device for a cloud native orchestration and scheduling system, and a storage medium.

### BACKGROUND

In recent years, the concept of cloud native has gradually become popular. Cloud native aims to realize a more efficient, reliable, flexible, and scalable application development and running mode. To achieve this objective, various cloud native orchestration and scheduling technologies emerge as required.

### SUMMARY

Embodiments of the present disclosure provide a scheduling method and device for a cloud native orchestration and scheduling system, and a storage medium.

In a first aspect, an embodiment of the present disclosure provides a scheduling method for a cloud native orchestration and scheduling system, including:
determining, in response to a rule plugin selection instruction, a target judgment rule plugin from multiple preset judgment rule plugins included in a preset judgment rule plugin set, and loading the target judgment rule plugin into a scheduler of the cloud native orchestration and scheduling system, where any judgment rule plugin is configured with at least one preset judgment rule for judging whether an instance is allowed to be preempted;
sequentially judging, by using the target judgment rule plugin and for a to-be-deployed instance, whether any instance on any node in the cloud native orchestration and scheduling system is allowed to be preempted by the to-be-deployed instance;
if there is an instance allowed to be preempted by the to-be-deployed instance on the any node, determining the any node as a candidate to-be-preempted node, and determining a candidate to-be-preempted instance on the candidate to-be-preempted node according to the to-be-deployed instance and the instance allowed to be preempted on the candidate to-be-preempted node; and
sorting candidate to-be-preempted nodes by using a preset comparison plugin in the scheduler, determining a target to-be-preempted node according to a sorting result, and controlling the to-be-deployed instance to preempt the candidate to-be-preempted instance on the target to-be-preempted node.

In a second aspect, an embodiment of the present disclosure provides a scheduling device for a cloud native orchestration and scheduling system, including:
a rule selection unit, configured to determine a target judgment rule plugin from multiple preset judgment rule plugins included in a preset judgment rule plugin set in response to a rule plugin selection instruction, and load the target judgment rule plugin into a scheduler of the cloud native orchestration and scheduling system, where any judgment rule plugin is configured with at least one preset judgment rule for judging whether an instance is allowed to be preempted;
a processing unit, configured to sequentially judge, by using the target judgment rule plugin and for a to-be-deployed instance, whether any instance on any node in the cloud native orchestration and scheduling system is allowed to be preempted by the to-be-deployed instance, and if there is an instance allowed to be preempted by the to-be-deployed instance on the any node, determine the any node as a candidate to-be-preempted node, and determine a candidate to-be-preempted instance on the candidate to-be-preempted node according to the to-be-deployed instance and the instance allowed to be preempted on the candidate to-be-preempted node; and
a preemption unit, configured to sort candidate to-be-preempted nodes by using a preset comparison plugin in the scheduler, determine a target to-be-preempted node according to a sorting result, and control the to-be-deployed instance to preempt the candidate to-be-preempted instance on the target to-be-preempted node.

In a third aspect, an embodiment of the present disclosure provides an electronic device, including: at least one processor and a memory;
where the memory stores computer-executable instructions; and
the at least one processor executes the computer-executable instructions stored in the memory, to enable the at least one processor to perform the scheduling method for the cloud native orchestration and scheduling system according to the first aspect and various possible designs of the first aspect.

In a fourth aspect, an embodiment of the present disclosure provides a computer-readable storage medium, where the computer-readable storage medium stores computer-executable instructions, and when a processor executes the computer-executable instructions, the scheduling method for the cloud native orchestration and scheduling system according to the first aspect and various possible designs of the first aspect is implemented.

In a fifth aspect, an embodiment of the present disclosure provides a computer program product, including computer-executable instructions, where when a processor executes the computer-executable instructions, the scheduling method for the cloud native orchestration and scheduling system according to the first aspect and various possible designs of the first aspect is implemented.

### BRIEF DESCRIPTION OF THE DRAWINGS

In order to illustrate the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art may still derive other drawings from these drawings without creative efforts.

FIG. 1 is a schematic diagram of an application scenario of a scheduling method for a cloud native orchestration and scheduling system according to an embodiment of the present disclosure;

FIG. 2 is a schematic flowchart of a scheduling method for a cloud native orchestration and scheduling system according to an embodiment of the present disclosure;

FIG. 3 is a schematic flowchart of a scheduling method for a cloud native orchestration and scheduling system according to another embodiment of the present disclosure;

FIG. 4 is a schematic diagram of interfaces of a judgment rule plugin according to an embodiment of the present disclosure;

FIG. 5 is a block diagram of a structure of a scheduling device for a cloud native orchestration and scheduling system according to an embodiment of the present disclosure; and

FIG. 6 is a schematic diagram of a hardware structure of an electronic device according to an embodiment of the present disclosure.

### DETAILED DESCRIPTION OF EMBODIMENTS

To make the objectives, technical solutions, and advantages of the embodiments of the present disclosure clearer, the following clearly and comprehensively describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

Cloud native orchestration and scheduling refer to a process of effectively managing and scheduling containerized workloads in cloud native applications. It is necessary to select appropriate resources for an application in a cluster, and when there are no directly available resources in the cluster, it is necessary to obtain resources for the application through preemption. Preemption refers to a process of terminating a low-priority application so that a high-priority application can be scheduled to run. This mechanism ensures that a key workload in a cluster can obtain sufficient computing resources according to its priority and requirements, thereby maintaining the stability and reliability of the system.

However, in the prior art, cloud native orchestration and scheduling are usually implemented based on a preset preemption rule. However, the existing preemption mechanism is relatively weak in extensibility, and the preset preemption rule cannot be flexibly added or deleted, which cannot meet a flexible preemption requirement.

In the prior art, cloud native orchestration and scheduling are usually implemented based on a preset preemption rule, and different orchestration systems have different preemption rules. The following shows the preemption mechanisms of several common types of orchestration and scheduling technologies.

### 1) Kubernetes (K8S) Default Scheduler

Kubernetes, as a de facto standard in the field of cloud native orchestration and scheduling, is being accepted and recognized by more and more companies. K8S Default Scheduler, as a scheduler that is used by default in K8S, is also being widely used. The preemption of K8S Default Scheduler is divided into two stages: in the first stage, candidate nodes are selected; and in the second stage, the most appropriate target node is selected from these candidate nodes.

In the first stage, all nodes need to be traversed, and all instances with lower priorities than a to-be-scheduled instance on the nodes are selected as instances allowed to be preempted (Candidate Victims) and removed from the nodes. Then, these instances allowed to be preempted are added back to the nodes in the order of priorities from high to low. If the node is still schedulable when any instance allowed to be preempted is added back to the node, the instance allowed to be preempted does not need to be preempted; if the node is not schedulable at this time, the instance allowed to be preempted needs to be preempted.

In the second stage, the instance that needs to be preempted on each node is scored through an abstracted score interface, to obtain a score corresponding to each node, and the node with the highest score is selected as the most appropriate target node for final preemption.

### 2) Yarn Scheduler

Yarn scheduler (Yarn Scheduler) does not have an explicit preemption mechanism like K8S Default Scheduler, but it allows resource management and scheduling to be performed for jobs with different priorities, to ensure that important jobs can preferentially obtain resources. Although there is no direct preemption mechanism, a similar preemption effect can be achieved by adjusting the priorities of queues and resource allocation policies, to ensure that key jobs can be completed in time.

### 3) Yunikorn Scheduler

The preemption strategy of Yunikorn scheduler (Yunikorn Scheduler) is similar to that of K8S Default Scheduler, but when selecting candidate nodes in the first stage, in addition to the priority, the fairness of queues is also considered, to ensure that each queue can obtain its guaranteed resource capacity as much as possible. In addition, in the second stage, each candidate node is scored by using a fixed simple rule, and there is no universal score interface abstracted like K8S Default Scheduler.

However, the existing preemption mechanism is relatively weak in extensibility, and the preset preemption rule cannot be flexibly added or deleted, which cannot meet a flexible preemption requirement. In addition, in the current preemption mechanism, the required preemption rule is written in a program code, and all preemption rules need to be run when the program is running, while some preemption rules cannot be flexibly stopped or skipped.

In order to solve the above technical problem, the present disclosure provides a scheduling method for a cloud native orchestration and scheduling system. The judgment rule used to judge whether an instance is allowed to be preempted may be packaged in the form of a plugin, so that the coupling between a scheduler and the judgment rule can be reduced, the loading and unloading of the plugin can be flexibly controlled, and the flexibility and extensibility of the scheduler in configuring the judgment rule are improved, which facilitates the addition and deletion of the judgment rule, and also facilitates the forced stop in the judgment process, thereby meeting a preemption requirement with higher flexibility requirements.

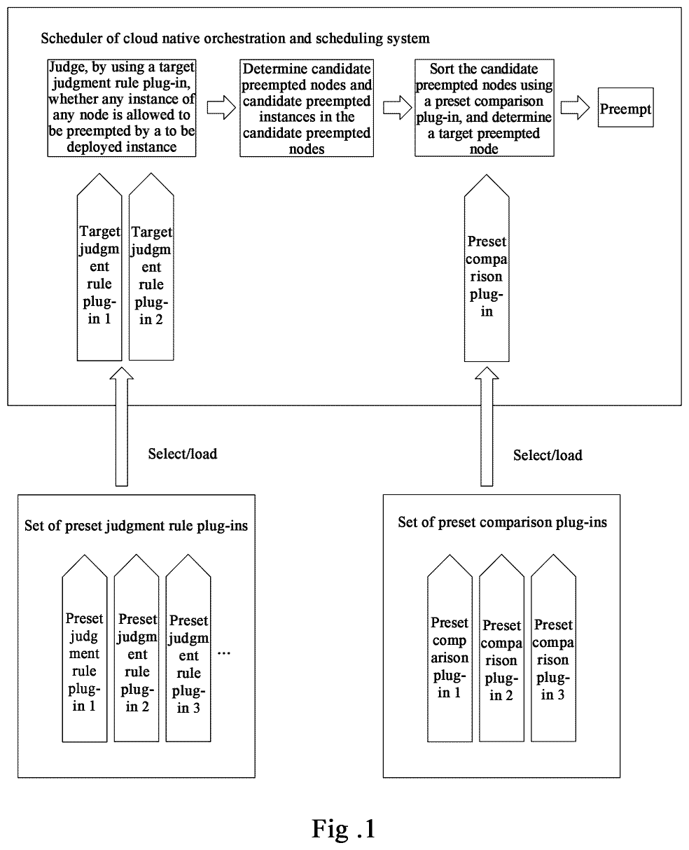

Specifically, as shown in FIG. 1, a target judgment rule plugin may be determined from multiple preset judgment rule plugins included in the preset judgment rule plugin set in response to the rule plugin selection instruction, and the target judgment rule plugin is loaded into the scheduler of the cloud native orchestration and scheduling system. For the to-be-deployed instance, whether any instance on any node in the cloud native orchestration and scheduling system is allowed to be preempted by the to-be-deployed instance is sequentially judged by using the target judgment rule plugin. If there is the instance allowed to be preempted by the to-be-deployed instance on the any node, the any node is determined as the candidate to-be-preempted node, and the candidate to-be-preempted instance on the candidate to-be-preempted node is determined according to the to-be-deployed instance and the instance allowed to be preempted on the candidate to-be-preempted node. The candidate to-be-preempted nodes are sorted by using the preset comparison plugin in the scheduler, the target to-be-preempted node is determined according to the sorting result, and the to-be-deployed instance is controlled to preempt the candidate to-be-preempted instance on the target to-be-preempted node.

In addition, only one preset comparison plugin may exist in the scheduler. Optionally, the user may set a preset comparison rule of the preset comparison plugin, or may configure different preset comparison plugins, where the preset comparison rules in the different preset comparison plugins are different. Multiple preset comparison plugins constitute a preset comparison plugin set, and one preset comparison plugin may be determined from the preset comparison plugin set and loaded into the scheduler, as shown in FIG. 1, to realize the flexible selection of the preset comparison rule.

The following gives a detailed introduction to the scheduling method for the cloud native orchestration and scheduling system of the present disclosure with reference to specific embodiments.

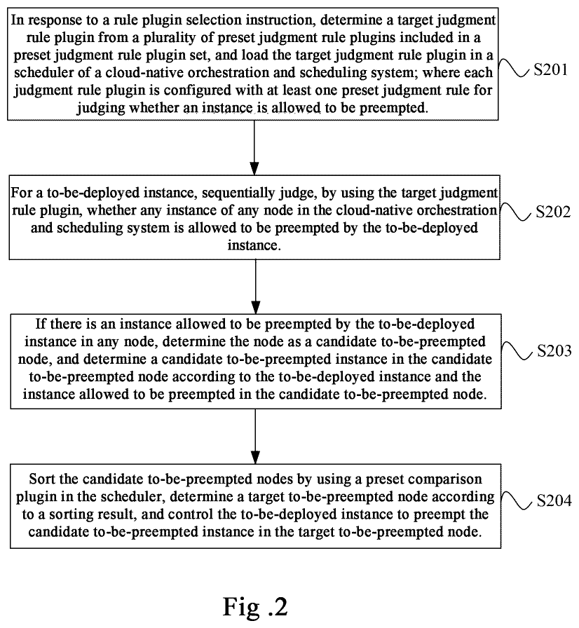

FIG. 2 is a schematic flowchart of a scheduling method for a cloud native orchestration and scheduling system according to an embodiment of the present disclosure. The method in this embodiment may be applied to a scheduler of a cloud native orchestration and scheduling system. The scheduling method for a cloud native orchestration and scheduling system provided in this embodiment includes the following steps.

S201: in response to a rule plugin selection instruction, determine a target judgment rule plugin from a plurality of preset judgment rule plugins included in a preset judgment rule plugin set and load the target judgment rule plugin into the scheduler of the cloud native orchestration and scheduling system, where each judgment rule plugin is configured with at least one preset judgment rule for judging whether an instance is allowed to be preempted.

In this embodiment, for a to-be-deployed instance, when the remaining resources of all nodes in the cloud native orchestration and scheduling system are insufficient to deploy the to-be-deployed instance, preemption needs to be performed in the cloud native orchestration and scheduling system, that is, one or more existing instances on a node are deleted to free up resources for deploying the to-be-deployed instance. However, which instances on any node are allowed to be preempted by the to-be-deployed instance and which instances are not allowed to be preempted by the to-be-deployed instance may be judged by the scheduler of the cloud native orchestration and scheduling system based on some judgment rules, and in different scenarios, the judgment rules may be different. For example, in some scenarios, judgment is performed based on the priority, and an existing instance with a higher priority than that of the to-be-deployed instance is not allowed to be preempted. In some scenarios, judgment is performed based on the preemption frequency, and the preemption frequency of any existing instance cannot exceed a preset frequency threshold, and an existing instance with a preemption frequency reaching the preset frequency threshold is not allowed to be preempted. Certainly, there may be various other rules, which will not be described in detail here.

In order to facilitate the scheduler of the cloud native orchestration and scheduling system to flexibly change the judgment rule, in this embodiment, each type or multiple types of judgment rules are packaged in the form of a plugin in advance, and different preset judgment rule plugins constitute a preset judgment rule plugin set. Furthermore, one or more preset judgment rule plugins may be flexibly selected from the preset judgment rule plugin set as the target judgment rule plugin according to the requirement in the rule plugin selection instruction, and the target judgment rule plugin is loaded into the scheduler. Certainly, the loaded target judgment rule plugin may also be flexibly uninstalled or skipped according to the requirement. In this embodiment, each type or multiple types of judgment rules are packaged in the form of the plugin, so that the coupling between the scheduler and the judgment rule can be reduced, and the flexibility and extensibility of the scheduler in configuring the judgment rule are improved. The addition and deletion of the judgment rule are more convenient, less invasive, and the code readability is stronger. Optionally, the scheduler may also automatically select the target judgment rule plugin, and the selection process is not limited here.

S202: for a to-be-deployed instance, sequentially judge, by using the target judgment rule plugin, whether any instance on any node in the cloud native orchestration and scheduling system is allowed to be preempted by the to-be-deployed instance.

In this embodiment, after the target judgment rule plugin is loaded into the scheduler, whether any instance on any node in the cloud native orchestration and scheduling system is allowed to be preempted by the to-be-deployed instance may be sequentially judged by using the target judgment rule plugin. Optionally, each instance on each node in the cloud native orchestration and scheduling system may be traversed, and whether each instance is allowed to be preempted by the to-be-deployed instance is sequentially judged by using the target judgment rule plugin.

Optionally, input information of the target judgment rule plugin may be acquired, where the input information includes one or more of: information about the to-be-deployed instance, information about the any node, or information about any instance on the any node; and
the input information is inputted into the target judgment rule plugin, and whether the any instance is allowed to be preempted by the to-be-deployed instance is judged by using a preset judgment rule in the target judgment rule plugin.

In this embodiment, when the target judgment rule plugin judges whether any instance on any node in the cloud native orchestration and scheduling system is allowed to be preempted by the to-be-deployed instance, the judgment needs to be performed based on some information, and the information required by different target judgment rule plugins may be different, including but not limited to one or more of: the information about the to-be-deployed instance, the information about the any node, or the information about any instance on the any node. Therefore, in this embodiment, the above information required by the target judgment rule plugin may be acquired first and used as the input information, and the input information is inputted into the target judgment rule plugin. Then, in the target judgment rule plugin, whether the any instance is allowed to be preempted by the to-be-deployed instance is judged by using the preset judgment rule based on the input information.

Optionally, multiple target judgment rule plugins may exist that are selected and loaded according to the rule plugin selection instruction, and the multiple target judgment rule plugins are configured with a preset triggering order, where the preset triggering order may be configured in the rule plugin selection instruction, or configured according to a separate triggering order setting instruction, or may also be determined in any other feasible manner, which is not limited here.

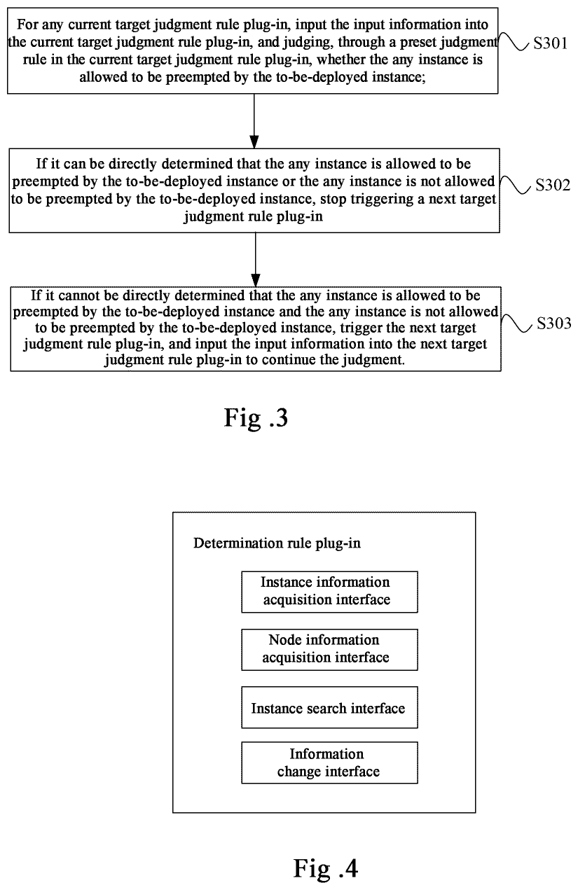

Further, whether the any instance is allowed to be preempted by the to-be-deployed instance is judged by using the preset judgment rule in the target judgment rule plugin. Specifically, as shown in FIG. 3, the method includes the following steps.

S301: For any current target judgment rule plugin, input the input information into the current target judgment rule plugin, and judge, by using a preset judgment rule in the current target judgment rule plugin, whether the any instance is allowed to be preempted by the to-be-deployed instance.

S302: If it can be directly determined that the any instance is allowed to be preempted by the to-be-deployed instance or is not allowed to be preempted by the to-be-deployed instance, stop triggering a next target judgment rule plugin; or

S303: If it cannot be directly determined that the any instance is allowed to be preempted by the to-be-deployed instance or is not allowed to be preempted by the to-be-deployed instance, trigger the next target judgment rule plugin, and input the input information into the next target judgment rule plugin to continue the judgment.

In this embodiment, because multiple target judgment rule plugins exist, for any instance, each target judgment rule plugin needs to be used for judgment in turn. In order to avoid resource waste and improve the judgment efficiency, when any target judgment rule plugin judges that the instance is allowed to be preempted by the to-be-deployed instance or is not allowed to be preempted by the to-be-deployed instance, the judgment of subsequent target judgment rule plugins may be stopped from being triggered.

In specific implementation, for any instance, input information of a first target judgment rule plugin is acquired first and inputted into the first target judgment rule plugin. If the first target judgment rule plugin can directly determine that the instance is allowed to be preempted by the to-be-deployed instance or is not allowed to be preempted by the to-be-deployed instance, the triggering of a second target judgment rule plugin is stopped. If the first target judgment rule plugin cannot directly determine that the instance is allowed to be preempted by the to-be-deployed instance or is not allowed to be preempted by the to-be-deployed instance, input information of the second target judgment rule plugin is acquired and inputted into the second target judgment rule plugin. If the second target judgment rule plugin can directly determine that the instance is allowed to be preempted by the to-be-deployed instance or is not allowed to be preempted by the to-be-deployed instance, the triggering of a third target judgment rule plugin is stopped. If the second target judgment rule plugin cannot directly determine that the instance is allowed to be preempted by the to-be-deployed instance or is not allowed to be preempted by the to-be-deployed instance, input information of the third target judgment rule plugin is acquired and inputted into the third target judgment rule plugin, to continue the judgment of the third target judgment rule plugin. By analogy, until it is determined that the instance is allowed to be preempted by the to-be-deployed instance or is not allowed to be preempted by the to-be-deployed instance.

S203: If there is the instance allowed to be preempted by the to-be-deployed instance on the any node, determine the any node as a candidate to-be-preempted node, and determine a candidate to-be-preempted instance on the candidate to-be-preempted node according to the to-be-deployed instance and the instance allowed to be preempted on the candidate to-be-preempted node.

In this embodiment, for an existing instance on any node, after judgment is sequentially performed by using the target judgment rule plugin, if there is the instance allowed to be preempted by the to-be-deployed instance on the node, the to-be-deployed instance may be preempted on the node, and the node may be determined as the candidate to-be-preempted node.

Further, because there may be multiple instances allowed to be preempted by the to-be-deployed instance on the candidate to-be-preempted node, it is not necessary to preempt all the instances allowed to be preempted by the to-be-deployed instance, and the deployment of the to-be-deployed instance may be satisfied by preempting one or more of these instances. Therefore, one or more of the instances allowed to be preempted need to be selected from the candidate to-be-preempted node and used as the to-be-preempted instance specified by the candidate to-be-preempted node for the to-be-deployed instance. Here, the to-be-preempted instance specified by the candidate to-be-preempted node for the to-be-deployed instance is recorded as the candidate to-be-preempted instance corresponding to the candidate to-be-preempted node, that is, if the to-be-deployed instance is deployed on the candidate to-be-preempted node, the deployment of the to-be-deployed instance may be realized by preempting the candidate to-be-preempted instance.

Optionally, when the candidate to-be-preempted instance on the candidate to-be-preempted node is determined according to the to-be-deployed instance and the instance allowed to be preempted on the candidate to-be-preempted node, the instance allowed to be preempted on the candidate to-be-preempted node may be removed, and in the case where the to-be-deployed instance is deployed on the candidate to-be-preempted node, the instance allowed to be preempted is deployed back to the candidate to-be-preempted node in the order of priorities from high to low, until the candidate to-be-preempted node cannot continue to be deployed, and the remaining instance allowed to be preempted that is not deployed to the candidate to-be-preempted node is determined as the candidate to-be-preempted instance on the candidate to-be-preempted node.

For example, it is assumed that the instance allowed to be preempted on the candidate to-be-preempted node includes instance 1, instance 2, and instance 3, where instance 1 has the highest priority, and instance 3 has the lowest priority, instance 1, instance 2, and instance 3 are removed from the candidate to-be-preempted node, and the to-be-deployed instance is deployed on the candidate to-be-preempted node. Then, an attempt is made to deploy instance 1 back to the candidate to-be-preempted node according to the priorities from high to low. If instance 1 cannot be deployed, it indicates that the remaining resources are insufficient to deploy instance 1 after the to-be-deployed instance is deployed, and instance 1 is used as a candidate to-be-preempted instance. Whether instance 1 can be deployed or not, an attempt needs to be continued to deploy instance 2. If instance 2 cannot be deployed, it indicates that the remaining resources are insufficient to deploy instance 2 after the to-be-deployed instance is deployed, and instance 2 is used as a candidate to-be-preempted instance. Whether instance 2 can be deployed or not, an attempt also needs to be continued to deploy instance 3. If instance 3 cannot be deployed, it indicates that the remaining resources are insufficient to deploy instance 3 after the to-be-deployed instance is deployed, and instance 3 is used as a candidate to-be-preempted instance. After the above judgment is completed, all instances that cannot be deployed back to the candidate to-be-preempted node are used as candidate to-be-preempted instances. It should be noted that the above process may be actually performed (certainly, if the candidate to-be-preempted node is not determined as the final target to-be
d nodes and used as the target to-be-preempted node, and the to-be-deployed instance is finally controlled to preempt the candidate to-be-preempted instance on the target to-be-preempted node, that is, the candidate to-be-preempted instance on the target to-be-preempted node is removed, and the to-be-deployed instance is deployed on the target to-be-preempted node.

In this embodiment, when the most appropriate candidate to-be-preempted node is selected from the candidate to-be-preempted nodes, the candidate to-be-preempted nodes may be sorted. In this embodiment, a plugin is also used. The candidate to-be-preempted nodes are sorted by using the preset comparison-preempted node, the original state of the candidate to-be-preempted node also needs to be restored), or may be performed in a simulation manner to avoid affecting the normal running of the instances on the candidate to-be-preempted node.

Certainly, in this embodiment, any other feasible solution may also be used when the candidate to-be-preempted instance on the candidate to-be-preempted node is determined, for example, selection based on the size of a resource, selection based on the size of a cost or a price, etc., which will not be described in detail here.

S204: Sort the candidate to-be-preempted nodes by using the preset comparison plugin in the scheduler, determine the target to-be-preempted node according to the sorting result, and control the to-be-deployed instance to preempt the candidate to-be-preempted instance on the target to-be-preempted node.

In this embodiment, after the candidate to-be-preempted instance on each candidate to-be-preempted node is determined, the most appropriate candidate to-be-preempted node may be selected from the candidate to-be-preempted plugin in the scheduler. The preset comparison plugin is configured with the preset comparison rule, and the comparison between the candidate to-be-preempted nodes can be realized through the preset comparison rule, so as to realize the sorting. The preset comparison rule may be a comparison based on a cost or a price, or may be a comparison based on an affinity with the to-be-deployed instance. In addition, the comparison may be performed based on a comparison rule associated with the preset judgment rule in the target judgment rule plugin, such as the priority, the preemption frequency, etc. Certainly, the comparison may be performed based on any other feasible rule, which is not limited here.

Further, in an optional embodiment, any two candidate to-be-preempted nodes may be compared in the preset comparison plugin according to the preset comparison rule, and the candidate to-be-preempted nodes are sorted according to a comparison result of the any two candidate to-be-preempted nodes. In this embodiment, the candidate to-be-preempted nodes are pairwise compared in the preset comparison plugin, and a sorting method such as a bubble method is used to sort the candidate to-be-preempted nodes based on a comparison result of the pairwise comparison.

In specific implementation, scores of any two candidate to-be-preempted nodes may be separately obtained in the preset comparison plugin according to the preset comparison rule, where the score of any candidate to-be-preempted node is used to evaluate the suitability of the candidate to-be-preempted node being preempted, that is, the higher the score of the candidate to-be-preempted node, the more suitable the candidate to-be-preempted node is as the target to-be-preempted node. Furthermore, the any two candidate to-be-preempted nodes may be compared based on the scores. Certainly, all the candidate to-be-preempted nodes may also be directly sorted based on the scores.

In the above embodiments, the user may set the preset comparison rule of the preset comparison plugin, and the user may trigger a preset comparison rule setting instruction. The scheduler completes the setting of the preset comparison rule of the preset comparison plugin in response to the preset comparison rule setting instruction. Optionally, the preset comparison rule may be carried in the preset comparison rule setting instruction, or multiple alternative comparison rules may be provided for the user to select. In addition, different preset comparison plugins may be configured, where the preset comparison rules in the different preset comparison plugins are different. Multiple preset comparison plugins constitute the preset comparison plugin set, and one preset comparison plugin may be selected from the preset comparison plugin set and loaded into the scheduler, to realize the flexible selection of the preset comparison rule.

Optionally, when setting the preset comparison rule of the preset comparison plugin, the preset comparison rule may be a comparison rule associated with the preset judgment rule in the target judgment rule plugin, or may be another comparison rule.

According to the scheduling method for the cloud native orchestration and scheduling system provided in this embodiment, the target judgment rule plugin is determined from the multiple preset judgment rule plugins included in the preset judgment rule plugin set in response to the rule plugin selection instruction, and the target judgment rule plugin is loaded into the scheduler of the cloud native orchestration and scheduling system, where any judgment rule plugin is configured with the at least one preset judgment rule for judging whether the instance is allowed to be preempted; for the to-be-deployed instance, whether any instance on any node in the cloud native orchestration and scheduling system is allowed to be preempted by the to-be-deployed instance is sequentially judged by using the target judgment rule plugin; if there is the instance allowed to be preempted by the to-be-deployed instance on the any node, the any node is determined as the candidate to-be-preempted node, and the candidate to-be-preempted instance on the candidate to-be-preempted node is determined according to the to-be-deployed instance and the instance allowed to be preempted on the candidate to-be-preempted node; the candidate to-be-preempted nodes are sorted by using the preset comparison plugin in the scheduler, the target to-be-preempted node is determined according to the sorting result, and the to-be-deployed instance is controlled to preempt the candidate to-be-preempted instance on the target to-be-preempted node. In this embodiment, the judgment rule used to judge whether the instance is allowed to be preempted is packaged in the form of the plugin, so that the coupling between the scheduler and the judgment rule can be reduced, the loading and unloading of the plugin can be flexibly controlled, and the flexibility and extensibility of the scheduler in configuring the judgment rule are improved, which facilitates the addition and deletion of the judgment rule, and also facilitates the forced stop in the judgment process, thereby meeting a preemption requirement with higher flexibility requirements.

On the basis of any of the above embodiments, as shown in FIG. 4, any judgment rule plugin may include the following interfaces.
1) An instance information acquiring interface is configured to acquire information about any instance on any node, for use as a basis for judgment by using a judgment rule. Optionally, the instance information acquiring interface may acquire the information about any instance from the dimension of a cluster, for example, information about each instance included in a cluster, instance disruption budget (Pod Disruption Budget, PDB) information, and the amount of resources reserved by each cluster. The cluster may be an instance belonging to the same service. The PDB information includes the minimum number of instances included in the cluster (the number of instances in the cluster cannot be less than the minimum number after preemption). The amount of resources reserved by each cluster is the minimum amount of resources required by the cluster (the amount of resources in the cluster cannot be less than the minimum amount of resources after preemption). Optionally, the instance information acquiring interface may input information such as a to-be-scheduled instance, a state of the to-be-scheduled instance, and a state of the cluster, to calculate the information about the required instance and store the information into the state of the instance, and calculate the information about the required cluster and store the information into the state of the cluster, to avoid subsequent repeated calculation.
2) A node information acquiring interface is configured to acquire information about any node, for use as a basis for judgment by using a judgment rule. Optionally, the node information acquiring interface may acquire a machine feature, a label, a total amount of resources, information about instances on the node, states of the instances, and the like of the node. Optionally, the node information acquiring interface may input information such as a to-be-scheduled instance, a node, a state of the to-be-scheduled instance, and a state of the node, to calculate the information about the required node and store the information into the state of the node, to avoid subsequent repeated calculation.
3) An instance searching interface is configured to judge, by using a preset judgment rule and according to one or more of: the information about the to-be-deployed instance, the information about the any node, or the information about the any instance, whether the instance is allowed to be preempted by the to-be-deployed instance. The input information may be acquired from the instance information acquiring interface and/or the node information acquiring interface. The output of the instance searching interface includes three results: the instance is allowed to be preempted by the to-be-deployed instance, the instance is not allowed to be preempted by the to-be-deployed instance, and the preemption is not blocked. The preemption not being blocked indicates that whether the preemption is allowed cannot be directly determined, and the judgment of a subsequent other judgment rule plugin needs to be continued.
4) An information changing interface is configured to: after the instance searching interface determines that the any instance is allowed to be preempted by the to-be-deployed instance, determine information about other instances that needs to be changed in the case where the instance is preempted through the information changing interface, and then change the information about the other instances, so as to find some potential instances allowed to be preempted.

It should be noted that not all of the above four interfaces are necessary for the judgment rule plugin, where the instance searching interface is necessary, and the other three interfaces may be configured according to actual requirements.

Optionally, based on the above interfaces, in the above embodiment, when the input information of the target judgment rule plugin is acquired, the information about the any instance may be acquired by using the instance information acquiring interface of the target judgment rule plugin and stored; and/or the information about the any node may be acquired by using the node information acquiring interface of the target judgment rule plugin and stored.

Optionally, after whether the any instance on the any node in the cloud native orchestration and scheduling system is allowed to be preempted by the to-be-deployed instance is sequentially judged by using the target judgment rule plugin, if it is determined, by using the target judgment rule plugin, that the any instance on the any node is allowed to be preempted by the to-be-deployed instance, the information about the other instances that needs to be changed in the case where the instance is preempted is determined through the information changing interface of the target judgment rule plugin, and the information about the other instances is changed.

In this embodiment, the information may be calculated and stored at three different levels: the cluster, the node, and the instance, through the above interfaces, so that the calculation is performed in advance, and recalculation is not required every time the judgment is performed based on the judgment rule, thereby reducing the number of times of repeated calculation.

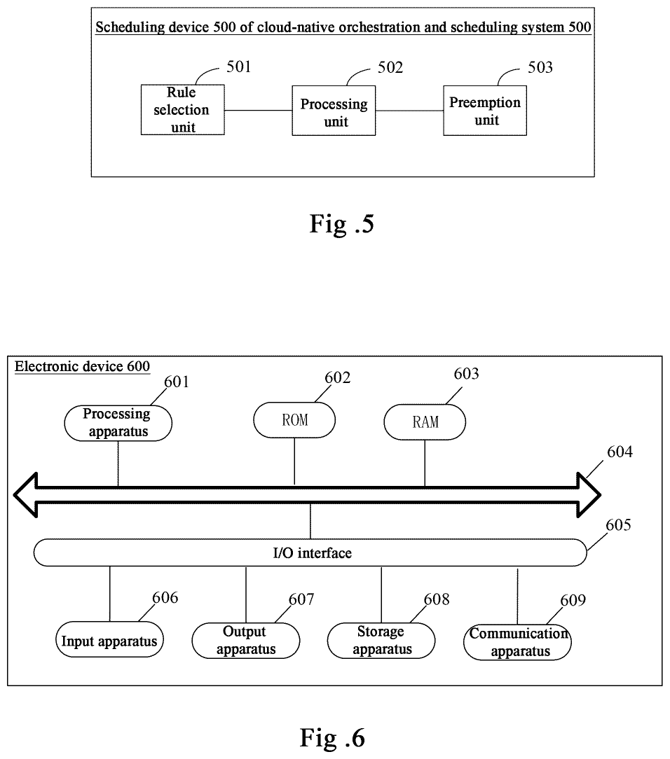

Corresponding to the scheduling method for the cloud native orchestration and scheduling system in the above embodiment, FIG. 5 is a block diagram of a structure of a scheduling device for a cloud native orchestration and scheduling system according to an embodiment of the present disclosure. For ease of explanation, only parts related to the embodiments of the present disclosure are shown. Referring to FIG. 5, the scheduling device 500 for the cloud native orchestration and scheduling system includes: a rule selection unit 501, a processing unit 502, and a preemption unit 503.

The rule selection unit 501 is configured to determine a target judgment rule plugin from multiple preset judgment rule plugins included in a preset judgment rule plugin set in response to a rule plugin selection instruction, and load the target judgment rule plugin into a scheduler of the cloud native orchestration and scheduling system, where any judgment rule plugin is configured with at least one preset judgment rule for judging whether an instance is allowed to be preempted.

The processing unit 502 is configured to sequentially judge, by using the target judgment rule plugin and for a to-be-deployed instance, whether any instance on any node in the cloud native orchestration and scheduling system is allowed to be preempted by the to-be-deployed instance, and if there is an instance allowed to be preempted by the to-be-deployed instance on the any node, determine the any node as a candidate to-be-preempted node, and determine a candidate to-be-preempted instance on the candidate to-be-preempted node according to the to-be-deployed instance and the instance allowed to be preempted on the candidate to-be-preempted node.

The preemption unit 503 is configured to sort candidate to-be-preempted nodes by using a preset comparison plugin in the scheduler, determine a target to-be-preempted node according to a sorting result, and control the to-be-deployed instance to preempt the candidate to-be-preempted instance on the target to-be-preempted node.

In one or more embodiments of the present disclosure, when sequentially judging, by using the target judgment rule plugin, whether any instance on any node in the cloud native orchestration and scheduling system is allowed to be preempted by the to-be-deployed instance, the processing unit 502 is configured to:
acquire input information of the target judgment rule plugin, where the input information includes one or more of: information about the to-be-deployed instance, information about the any node, or information about any instance on the any node; and
input the input information into the target judgment rule plugin, and judge, by using a preset judgment rule in the target judgment rule plugin, whether the any instance is allowed to be preempted by the to-be-deployed instance.

In one or more embodiments of the present disclosure, multiple target judgment rule plugins exist, and the multiple target judgment rule plugins are configured with a preset trigger sequence. When inputting the input information into the target judgment rule plugin and judging, by using the preset judgment rule in the target judgment rule plugin, whether the any instance is allowed to be preempted by the to-be-deployed instance, the processing unit 502 is configured to:
for any current target judgment rule plugin, input the input information into the current target judgment rule plugin, and judge, by using a preset judgment rule in the current target judgment rule plugin, whether the any instance is allowed to be preempted by the to-be-deployed instance;
if it can be directly determined that the any instance is allowed to be preempted by the to-be-deployed instance or is not allowed to be preempted by the to-be-deployed instance, stop triggering a next target judgment rule plugin; or
if it cannot be directly determined that the any instance is allowed to be preempted by the to-be-deployed instance or is not allowed to be preempted by the to-be-deployed instance, trigger the next target judgment rule plugin, and input the input information into the next target judgment rule plugin to continue the judgment.

In one or more embodiments of the present disclosure, after sequentially judging, by using the target judgment rule plugin, whether any instance on any node in the cloud native orchestration and scheduling system is allowed to be preempted by the to-be-deployed instance, the processing unit 502 is further configured to:

if it is determined, by using the target judgment rule plugin, that any instance on any node is allowed to be preempted by the to-be-deployed instance, determine, through an information changing interface of the target judgment rule plugin, information about other instances that needs to be changed in the case where the instance is preempted, and change the information about the other instances.

In one or more embodiments of the present disclosure, when acquiring the input information of the target judgment rule plugin, the processing unit 502 is configured to:
acquire information about the any instance by using an instance information acquiring interface of the target judgment rule plugin and store the information about the any instance; and/or
acquire information about the any node by using a node information acquiring interface of the target judgment rule plugin and store the information about the any node.

In one or more embodiments of the present disclosure, when determining the candidate to-be-preempted instance on the candidate to-be-preempted node according to the to-be-deployed instance and the instance allowed to be preempted on the candidate to-be-preempted node, the processing unit 502 is configured to:
remove the instance allowed to be preempted on the candidate to-be-preempted node, and in the case where the to-be-deployed instance is deployed on the candidate to-be-preempted node, deploy the instance allowed to be preempted back to the candidate to-be-preempted node in the order of priorities from high to low, until the candidate to-be-preempted node cannot continue to be deployed, and determine the remaining instance allowed to be preempted that is not deployed to the candidate to-be-preempted node as the candidate to-be-preempted instance on the candidate to-be-preempted node.

In one or more embodiments of the present disclosure, when sorting the candidate to-be-preempted nodes by using the preset comparison plugin in the scheduler, the preemption unit 503 is configured to:
compare any two candidate to-be-preempted nodes in the preset comparison plugin according to a preset comparison rule, and sort the candidate to-be-preempted nodes according to a comparison result of the any two candidate to-be-preempted nodes.

In one or more embodiments of the present disclosure, when comparing any two candidate to-be-preempted nodes in the preset comparison plugin according to the preset comparison rule, the preemption unit 503 is configured to:
obtain scores of the any two candidate to-be-preempted nodes separately in the preset comparison plugin according to the preset comparison rule, and compare the any two candidate to-be-preempted nodes based on the scores, where the score of any candidate to-be-preempted node is used to evaluate the suitability of the candidate to-be-preempted node being preempted.

In one or more embodiments of the present disclosure, the preemption unit 503 is further configured to:
set the preset comparison rule of the preset comparison plugin in response to a preset comparison rule setting instruction, where the preset comparison rule is a comparison rule associated with the preset judgment rule in the target judgment rule plugin.

The device provided in this embodiment may be used to perform the technical solutions of the above method embodiments, and the implementation principles and technical effects thereof are similar, which will not be repeated in this embodiment.

According to the scheduling method and device for the cloud native orchestration and scheduling system, and the storage medium provided by the embodiments of the present disclosure, the target judgment rule plugin is determined from the multiple preset judgment rule plugins included in the preset judgment rule plugin set in response to the rule plugin selection instruction, and the target judgment rule plugin is loaded into the scheduler of the cloud native orchestration and scheduling system, where any judgment rule plugin is configured with the at least one preset judgment rule for judging whether the instance is allowed to be preempted; for the to-be-deployed instance, whether any instance on any node in the cloud native orchestration and scheduling system is allowed to be preempted by the to-be-deployed instance is sequentially judged by using the target judgment rule plugin; if there is the instance allowed to be preempted by the to-be-deployed instance on the any node, the any node is determined as the candidate to-be-preempted node, and the candidate to-be-preempted instance on the candidate to-be-preempted node is determined according to the to-be-deployed instance and the instance allowed to be preempted on the candidate to-be-preempted node; the candidate to-be-preempted nodes are sorted by using the preset comparison plugin in the scheduler, the target to-be-preempted node is determined according to the sorting result, and the to-be-deployed instance is controlled to preempt the candidate to-be-preempted instance on the target to-be-preempted node. In the embodiments of the present disclosure, the judgment rule used to judge whether the instance is allowed to be preempted is packaged in the form of the plugin, so that the coupling between the scheduler and the judgment rule can be reduced, the loading and unloading of the plugin can be flexibly controlled, and the flexibility and extensibility of the scheduler in configuring the judgment rule are improved, which facilitates the addition and deletion of the judgment rule, and also facilitates the forced stop in the judgment process, thereby meeting a preemption requirement with higher flexibility requirements.

FIG. 6 is a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a laptop, a digital broadcast receiver, a personal digital assistant (abbreviated as PDA), a tablet computer, a portable media player (abbreviated as PMP) and an in-vehicle terminal (such as an in-vehicle navigation terminal), and a stationary terminal such as a digital TV and a desktop computer. The electronic device shown in FIG. 6 is merely an example, and should not impose any limitation to the function and usage scope of the embodiments of the present disclosure.

As shown in FIG. 6, the electronic device 600 may include a processing apparatus (such as a central processing unit, a graphics processing unit, etc.) 601, which may perform various appropriate actions and processing according to a program stored in a read-only memory (abbreviated as ROM) 602 or a program loaded from a storage apparatus 608 into a random access memory (abbreviated as RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (abbreviated as LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that not all of the illustrated apparatuses are necessarily implemented or included. Alternatively, more or fewer apparatuses may be implemented or included.

In particular, according to the embodiments of the present disclosure, the processes described above with reference to the flowcharts may be implemented as computer software programs. For example, an embodiment of the present disclosure includes a computer program product, which includes a computer program carried on a computer-readable medium. The computer program includes program codes for executing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program. The program may be used by or in combination with an instruction execution system, apparatus, or device. In the present disclosure, the computer-readable signal medium may include a data signal propagated in a baseband or as a part of a carrier wave, where computer-readable program codes are carried in the data signal. The data signal propagated in this manner may be in multiple forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus, or device. The program codes contained in the computer-readable medium may be transmitted by any suitable medium, including but not limited to an electric wire, an optical cable, a radio frequency (RF), etc., or any suitable combination thereof.

The above computer-readable medium may be included in the above electronic device, or may also exist alone without being assembled into the electronic device.

The above computer-readable medium carries one or more programs, and the electronic device is caused to execute the methods described in the above embodiments when the one or more programs are executed by the electronic device.

The computer program codes for performing the operations of the present disclosure may be written in one or more programming languages or a combination thereof. The above programming languages include object-oriented programming languages such as Java, Smalltalk, and C++, as well as conventional procedural programming languages such as the “C” programming language or similar programming languages. The program codes may be executed entirely on a user's computer, partly on a user's computer, as a stand-alone software package, partly on a user's computer and partly on a remote computer, or entirely on a remote computer or a server. In the scenario involving the remote computer, the remote computer may be connected to the user's computer through any type of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowchart or block diagram may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments described in the present disclosure may be implemented in software or hardware. The name of a unit does not constitute a limitation of the unit itself under certain circumstances. For example, a first acquiring unit may also be described as “a unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination thereof.

In a first aspect, one or more embodiments of the present disclosure provide a scheduling method for a cloud native orchestration and scheduling system, including:
determining a target judgment rule plugin from a plurality of preset judgment rule plugins included in a preset judgment rule plugin set in response to a rule plugin selection instruction, and loading the target judgment rule plugin into a scheduler of the cloud native orchestration and scheduling system, where any judgment rule plugin is configured with at least one preset judgment rule for judging whether an instance is allowed to be preempted;
sequentially judging, by using the target judgment rule plugin and for a to-be-deployed instance, whether any instance on any node in the cloud native orchestration and scheduling system is allowed to be preempted by the to-be-deployed instance;
if there is an instance allowed to be preempted by the to-be-deployed instance on the any node, determining the any node as a candidate to-be-preempted node, and determining a candidate to-be-preempted instance on the candidate to-be-preempted node according to the to-be-deployed instance and the instance allowed to be preempted on the candidate to-be-preempted node; and
sorting candidate to-be-preempted nodes by using a preset comparison plugin in the scheduler, determining a target to-be-preempted node according to a sorting result, and controlling the to-be-deployed instance to preempt the candidate to-be-preempted instance on the target to-be-preempted node.

According to one or more embodiments of the present disclosure, the sequentially judging, by using the target judgment rule plugin, whether the any instance on the any node in the cloud native orchestration and scheduling system is allowed to be preempted by the to-be-deployed instance includes:
acquiring input information of the target judgment rule plugin, where the input information includes one or more of: information about the to-be-deployed instance, information about the any node, or information about the any instance; and
inputting the input information into the target judgment rule plugin, and judging, by using a preset judgment rule in the target judgment rule plugin, whether the any instance is allowed to be preempted by the to-be-deployed instance.

According to one or more embodiments of the present disclosure, multiple target judgment rule plugins exist, and the multiple target judgment rule plugins are configured with a preset triggering order; and the inputting the input information into the target judgment rule plugin and judging, by using the preset judgment rule in the target judgment rule plugin, whether the any instance is allowed to be preempted by the to-be-deployed instance includes:
for any current target judgment rule plugin, inputting the input information into the current target judgment rule plugin, and judging, by using a preset judgment rule in the current target judgment rule plugin, whether the any instance is allowed to be preempted by the to-be-deployed instance;
if it can be directly determined that the any instance is allowed to be preempted by the to-be-deployed instance or is not allowed to be preempted by the to-be-deployed instance, stopping triggering a next target judgment rule plugin; or
if it cannot be directly determined that the any instance is allowed to be preempted by the to-be-deployed instance or is not allowed to be preempted by the to-be-deployed instance, triggering the next target judgment rule plugin, and inputting the input information into the next target judgment rule plugin to continue the judgment.

According to one or more embodiments of the present disclosure, after the sequentially judging, by using the target judgment rule plugin, whether the any instance on the any node in the cloud native orchestration and scheduling system is allowed to be preempted by the to-be-deployed instance, the method further includes:
if it is determined, by using the target judgment rule plugin, that the any instance on the any node is allowed to be preempted by the to-be-deployed instance, determining, through an information changing interface of the target judgment rule plugin, information about other instances that needs to be changed in the case where the instance is preempted, and changing the information about the other instances.

According to one or more embodiments of the present disclosure, the acquiring the input information of the target judgment rule plugin includes:
acquiring information about the any instance by using an instance information acquiring interface of the target judgment rule plugin and storing the information about the any instance; and/or
acquiring information about the any node by using a node information acquiring interface of the target judgment rule plugin and storing the information about the any node.

According to one or more embodiments of the present disclosure, the determining the candidate to-be-preempted instance on the candidate to-be-preempted node according to the to-be-deployed instance and the instance allowed to be preempted on the candidate to-be-preempted node includes:
removing the instance allowed to be preempted on the candidate to-be-preempted node, and in the case where the to-be-deployed instance is deployed on the candidate to-be-preempted node, deploying the instance allowed to be preempted back to the candidate to-be-preempted node in the order of priorities from high to low, until the candidate to-be-preempted node cannot continue to be deployed, and determining the remaining instance allowed to be preempted that is not deployed to the candidate to-be-preempted node as the candidate to-be-preempted instance on the candidate to-be-preempted node.

According to one or more embodiments of the present disclosure, the sorting the candidate to-be-preempted nodes by using the preset comparison plugin in the scheduler includes:
comparing any two candidate to-be-preempted nodes in the preset comparison plugin according to a preset comparison rule, and sorting the candidate to-be-preempted nodes according to a comparison result of the any two candidate to-be-preempted nodes.

According to one or more embodiments of the present disclosure, the comparing any two candidate to-be-preempted nodes in the preset comparison plugin according to the preset comparison rule includes:
obtaining scores of the any two candidate to-be-preempted nodes separately in the preset comparison plugin according to the preset comparison rule, and comparing the any two candidate to-be-preempted nodes based on the scores, where the score of any candidate to-be-preempted node is used to evaluate the suitability of the candidate to-be-preempted node being preempted.

According to one or more embodiments of the present disclosure, the method further includes:
setting the preset comparison rule of the preset comparison plugin in response to a preset comparison rule setting instruction, where the preset comparison rule is a comparison rule associated with the preset judgment rule in the target judgment rule plugin.

In a second aspect, one or more embodiments of the present disclosure provide a scheduling device for a cloud native orchestration and scheduling system, including:
a rule selection unit configured to determine a target judgment rule plugin from a plurality of preset judgment rule plugins included in a preset judgment rule plugin set in response to a rule plugin selection instruction, and load the target judgment rule plugin into a scheduler of the cloud native orchestration and scheduling system, where any judgment rule plugin is configured with at least one preset judgment rule for judging whether an instance is allowed to be preempted;
a processing unit configured to sequentially judge, by using the target judgment rule plugin and for a to-be-deployed instance, whether any instance on any node in the cloud native orchestration and scheduling system is allowed to be preempted by the to-be-deployed instance, and if there is an instance allowed to be preempted by the to-be-deployed instance on the any node, determine the any node as a candidate to-be-preempted node, and determine a candidate to-be-preempted instance on the candidate to-be-preempted node according to the to-be-deployed instance and the instance allowed to be preempted on the candidate to-be-preempted node; and
a preemption unit configured to sort candidate to-be-preempted nodes by using a preset comparison plugin in the scheduler, determine a target to-be-preempted node according to a sorting result, and control the to-be-deployed instance to preempt the candidate to-be-preempted instance on the target to-be-preempted node.

According to one or more embodiments of the present disclosure, when sequentially judging, by using the target judgment rule plugin, whether the any instance on the any node in the cloud native orchestration and scheduling system is allowed to be preempted by the to-be-deployed instance, the processing unit is configured to:
acquire input information of the target judgment rule plugin, where the input information includes one or more of: information about the to-be-deployed instance, information about the any node, or information about the any instance; and
input the input information into the target judgment rule plugin, and judge, by using a preset judgment rule in the target judgment rule plugin, whether the any instance is allowed to be preempted by the to-be-deployed instance.

According to one or more embodiments of the present disclosure, multiple target judgment rule plugins exist, and the multiple target judgment rule plugins are configured with a preset triggering order; and when inputting the input information into the target judgment rule plugin and judging, by using the preset judgment rule in the target judgment rule plugin, whether the any instance is allowed to be preempted by the to-be-deployed instance, the processing unit is configured to:
for any current target judgment rule plugin, input the input information into the current target judgment rule plugin, and judge, by using a preset judgment rule in the current target judgment rule plugin, whether the any instance is allowed to be preempted by the to-be-deployed instance;
if it can be directly determined that the any instance is allowed to be preempted by the to-be-deployed instance or is not allowed to be preempted by the to-be-deployed instance, stop triggering a next target judgment rule plugin; or
if it cannot be directly determined that the any instance is allowed to be preempted by the to-be-deployed instance or is not allowed to be preempted by the to-be-deployed instance, trigger the next target judgment rule plugin, and input the input information into the next target judgment rule plugin to continue the judgment.

According to one or more embodiments of the present disclosure, after sequentially judging, by using the target judgment rule plugin, whether the any instance on the any node in the cloud native orchestration and scheduling system is allowed to be preempted by the to-be-deployed instance, the processing unit is further configured to:
if it is determined, by using the target judgment rule plugin, that the any instance on the any node is allowed to be preempted by the to-be-deployed instance, determine, through an information changing interface of the target judgment rule plugin, information about other instances that needs to be changed in the case where the instance is preempted, and change the information about the other instances.

According to one or more embodiments of the present disclosure, when acquiring the input information of the target judgment rule plugin, the processing unit is configured to:
acquire information about the any instance by using an instance information acquiring interface of the target judgment rule plugin and store the information about the any instance; and/or
acquire information about the any node by using a node information acquiring interface of the target judgment rule plugin and store the information about the any node.

According to one or more embodiments of the present disclosure, when determining the candidate to-be-preempted instance on the candidate to-be-preempted node according to the to-be-deployed instance and the instance allowed to be preempted on the candidate to-be-preempted node, the processing unit is configured to:
remove the instance allowed to be preempted on the candidate to-be-preempted node, and in the case where the to-be-deployed instance is deployed on the candidate to-be-preempted node, deploy the instance allowed to be preempted back to the candidate to-be-preempted node in the order of priorities from high to low, until the candidate to-be-preempted node cannot continue to be deployed, and determine the remaining instance allowed to be preempted that is not deployed to the candidate to-be-preempted node as the candidate to-be-preempted instance on the candidate to-be-preempted node.

According to one or more embodiments of the present disclosure, the preemption unit is further configured to:
compare any two candidate to-be-preempted nodes in the preset comparison plugin according to a preset comparison rule, and sort the candidate to-be-preempted nodes according to a comparison result of the any two candidate to-be-preempted nodes.

According to one or more embodiments of the present disclosure, the preemption unit is further configured to:
obtain scores of the any two candidate to-be-preempted nodes separately in the preset comparison plugin according to the preset comparison rule, and compare the any two candidate to-be-preempted nodes based on the scores, where the score of any candidate to-be-preempted node is used to evaluate the suitability of the candidate to-be-preempted node being preempted.

According to one or more embodiments of the present disclosure, the preemption unit is further configured to:
set the preset comparison rule of the preset comparison plugin in response to a preset comparison rule setting instruction, where the preset comparison rule is a comparison rule associated with the preset judgment rule in the target judgment rule plugin.

In a third aspect, one or more embodiments of the present disclosure provide an electronic device, including: at least one processor and a memory, where
the memory stores computer-executable instructions; and
the at least one processor executes the computer-executable instructions stored in the memory to cause the at least one processor to execute the scheduling method for the cloud native orchestration and scheduling system according to the above first aspect and various possible designs of the first aspect.

In a fourth aspect, one or more embodiments of the present disclosure provide a computer-readable storage medium storing computer-executable instructions which, when executed by a processor, implement the scheduling method for the cloud native orchestration and scheduling system according to the above first aspect and various possible designs of the first aspect.

In a fifth aspect, one or more embodiments of the present disclosure provide a computer program product, including computer-executable instructions which, when executed by a processor, implement the scheduling method for the cloud native orchestration and scheduling system according to the above first aspect and various possible designs of the first aspect.

The above description is merely preferred embodiments of the present disclosure and an illustration of the applied technical principles. Those skilled in the art should understand that the disclosure scope involved in the present disclosure is not limited to the technical solutions formed by the specific combination of the above technical features, and should also cover, without departing from the above disclosed concept, other technical solutions formed by any combination of the above technical features or their equivalents. For example, the technical solutions formed by replacing the above features with the technical features with similar functions disclosed in the present disclosure (but not limited to).

Furthermore, although operations are depicted in a particular order, this should not be understood as requiring these operations to be performed in the specific order shown or in a sequential order. Under certain circumstances, multitasking and parallel processing may be advantageous. Similarly, although the above discussion contains several specific implementation details, these should not be construed as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely exemplary forms for implementing the claims.

I/We claim:

1. A scheduling method for a cloud native orchestration and scheduling system, comprising:
determining, in response to a rule plugin selection instruction, a target judgment rule plugin from a plurality of preset judgment rule plugins comprised in a preset judgment rule plugin set, and loading the target judgment rule plugin into a scheduler of the cloud native orchestration and scheduling system, wherein each judgment rule plugin is configured with at least one preset judgment rule for judging whether an instance is allowed to be preempted;
sequentially judging, by using the target judgment rule plugin and for a to-be-deployed instance, whether any instance on any node in the cloud native orchestration and scheduling system is allowed to be preempted by the to-be-deployed instance;
if there is an instance allowed to be preempted by the to-be-deployed instance on the any node, determining the any node as a candidate to-be-preempted node, and determining a candidate to-be-preempted instance on the candidate to-be-preempted node according to the to-be-deployed instance and the instance allowed to be preempted on the candidate to-be-preempted node; and
sorting candidate to-be-preempted nodes by using a preset comparison plugin in the scheduler, determining a target to-be-preempted node according to a sorting result, and controlling the to-be-deployed instance to preempt the candidate to-be-preempted instance on the target to-be-preempted node.

2. The method according to claim 1, wherein the sequentially judging, by using the target judgment rule plugin, whether the any instance on the any node in the cloud native orchestration and scheduling system is allowed to be preempted by the to-be-deployed instance comprises:
acquiring input information of the target judgment rule plugin, wherein the input information comprises one or more of: information about the to-be-deployed instance, information about the any node, or information about the any instance; and
inputting the input information into the target judgment rule plugin, and judging, by using a preset judgment rule in the target judgment rule plugin, whether the any instance is allowed to be preempted by the to-be-deployed instance.

3. The method according to claim 2, wherein multiple target judgment rule plugins exist, and the multiple target judgment rule plugins are configured with a preset triggering order; and the inputting the input information into the target judgment rule plugin and judging, by using the preset judgment rule in the target judgment rule plugin, whether the any instance is allowed to be preempted by the to-be-deployed instance comprises:
for any current target judgment rule plugin, inputting the input information into the current target judgment rule plugin, and judging, by using a preset judgment rule in the current target judgment rule plugin, whether the any instance is allowed to be preempted by the to-be-deployed instance;
if it can be directly determined that the any instance is allowed to be preempted by the to-be-deployed instance or is not allowed to be preempted by the to-be-deployed instance, stopping triggering a next target judgment rule plugin; or
if it cannot be directly determined that the any instance is allowed to be preempted by the to-be-deployed instance or is not allowed to be preempted by the to-be-deployed instance, triggering the next target judgment rule plugin, and inputting the input information into the next target judgment rule plugin to continue the judgment.

4. The method according to claim 2, wherein after the sequentially judging, by using the target judgment rule plugin, whether the any instance on the any node in the cloud native orchestration and scheduling system is allowed to be preempted by the to-be-deployed instance, the method further comprises:
if it is determined, by using the target judgment rule plugin, that the any instance on the any node is allowed to be preempted by the to-be-deployed instance, determining, through an information changing interface of the target judgment rule plugin, information about other instances that needs to be changed in the case that the instance is preempted, and changing the information about the other instances.

5. The method according to claim 2, wherein the acquiring the input information of the target judgment rule plugin comprises:
acquiring information about the any instance by using an instance information acquiring interface of the target judgment rule plugin and storing the information about the any instance; and/or
acquiring information about the any node by using a node information acquiring interface of the target judgment rule plugin and storing the information about the any node.

6. The method according to claim 1, wherein the determining the candidate to-be-preempted instance on the candidate to-be-preempted node according to the to-be-deployed instance and the instance allowed to be preempted on the candidate to-be-preempted node comprises:
removing the instance allowed to be preempted on the candidate to-be-preempted node, and in the case that the to-be-deployed instance is deployed on the candidate to-be-preempted node, deploying the instance allowed to be preempted back to the candidate to-be-preempted node in the order of priorities from high to low, until the candidate to-be-preempted node cannot continue to be deployed, and determining the remaining instance allowed to be preempted that is not deployed to the candidate to-be-preempted node as the candidate to-be-preempted instance on the candidate to-be-preempted node.

7. The method according to claim 1, wherein sorting the candidate to-be-preempted nodes by using the preset comparison plugin in the scheduler comprises:
comparing any two candidate to-be-preempted nodes in the preset comparison plugin according to a preset comparison rule, and sorting the candidate to-be-preempted nodes according to a comparison result of the any two candidate to-be-preempted nodes.

8. The method according to claim 7, wherein comparing any two candidate to-be-preempted nodes in the preset comparison plugin according to the preset comparison rule comprises:
obtaining scores of the any two candidate to-be-preempted nodes separately in the preset comparison plugin according to the preset comparison rule, and comparing the any two candidate to-be-preempted nodes based on the scores, wherein a score of any candidate to-be-preempted node is used to evaluate suitability of the any candidate to-be-preempted node being preempted.

9. The method according to claim 7, further comprising:
setting a preset comparison rule of the preset comparison plugin in response to a preset comparison rule setting instruction, wherein the preset comparison rule is a comparison rule associated with the preset judgment rule in the target judgment rule plugin.

10. An electronic device, comprising:
at least one processor and a memory, wherein
the memory stores computer-executable instructions; and
the at least one processor executes the computer-executable instructions stored in the memory to cause the at least one processor to execute a method comprising:
determining, in response to a rule plugin selection instruction, a target judgment rule plugin from a plurality of preset judgment rule plugins comprised in a preset judgment rule plugin set, and loading the target judgment rule plugin into a scheduler of the cloud native orchestration and scheduling system, wherein each judgment rule plugin is configured with at least one preset judgment rule for judging whether an instance is allowed to be preempted;
sequentially judging, by using the target judgment rule plugin and for a to-be-deployed instance, whether any instance on any node in the cloud native orchestration and scheduling system is allowed to be preempted by the to-be-deployed instance;
if there is an instance allowed to be preempted by the to-be-deployed instance on the any node, determining the any node as a candidate to-be-preempted node, and determining a candidate to-be-preempted instance on the candidate to-be-preempted node according to the to-be-deployed instance and the instance allowed to be preempted on the candidate to-be-preempted node; and
sorting candidate to-be-preempted nodes by using a preset comparison plugin in the scheduler, determining a target to-be-preempted node according to a sorting result, and controlling the to-be-deployed instance to preempt the candidate to-be-preempted instance on the target to-be-preempted node.

11. The electronic device according to claim 10, wherein the sequentially judging, by using the target judgment rule plugin, whether the any instance on the any node in the cloud native orchestration and scheduling system is allowed to be preempted by the to-be-deployed instance comprises:
acquiring input information of the target judgment rule plugin, wherein the input information comprises one or more of: information about the to-be-deployed instance, information about the any node, or information about the any instance; and
inputting the input information into the target judgment rule plugin, and judging, by using a preset judgment rule in the target judgment rule plugin, whether the any instance is allowed to be preempted by the to-be-deployed instance.

12. The electronic device according to claim 11, wherein multiple target judgment rule plugins exist, and the multiple target judgment rule plugins are configured with a preset triggering order; and the inputting the input information into the target judgment rule plugin and judging, by using the preset judgment rule in the target judgment rule plugin, whether the any instance is allowed to be preempted by the to-be-deployed instance comprises:
for any current target judgment rule plugin, inputting the input information into the current target judgment rule plugin, and judging, by using a preset judgment rule in the current target judgment rule plugin, whether the any instance is allowed to be preempted by the to-be-deployed instance;
if it can be directly determined that the any instance is allowed to be preempted by the to-be-deployed instance or is not allowed to be preempted by the to-be-deployed instance, stopping triggering a next target judgment rule plugin; or
if it cannot be directly determined that the any instance is allowed to be preempted by the to-be-deployed instance or is not allowed to be preempted by the to-be-deployed instance, triggering the next target judgment rule plugin, and inputting the input information into the next target judgment rule plugin to continue the judgment.

13. The electronic device according to claim 11, wherein after the sequentially judging, by using the target judgment rule plugin, whether the any instance on the any node in the cloud native orchestration and scheduling system is allowed to be preempted by the to-be-deployed instance, the method further comprises:
if it is determined, by using the target judgment rule plugin, that the any instance on the any node is allowed to be preempted by the to-be-deployed instance, determining, through an information changing interface of the target judgment rule plugin, information about other instances that needs to be changed in the case that the instance is preempted, and changing the information about the other instances.

14. The electronic device according to claim 11, wherein the acquiring the input information of the target judgment rule plugin comprises:
acquiring information about the any instance by using an instance information acquiring interface of the target judgment rule plugin and storing the information about the any instance; and/or
acquiring information about the any node by using a node information acquiring interface of the target judgment rule plugin and storing the information about the any node.

15. The electronic device according to claim 10, wherein the determining the candidate to-be-preempted instance on the candidate to-be-preempted node according to the to-be-deployed instance and the instance allowed to be preempted on the candidate to-be-preempted node comprises:
removing the instance allowed to be preempted on the candidate to-be-preempted node, and in the case that the to-be-deployed instance is deployed on the candidate to-be-preempted node, deploying the instance allowed to be preempted back to the candidate to-be-preempted node in the order of priorities from high to low, until the candidate to-be-preempted node cannot continue to be deployed, and determining the remaining instance allowed to be preempted that is not deployed to the candidate to-be-preempted node as the candidate to-be-preempted instance on the candidate to-be-preempted node.

16. The electronic device according to claim 10, wherein sorting the candidate to-be-preempted nodes by using the preset comparison plugin in the scheduler comprises:
comparing any two candidate to-be-preempted nodes in the preset comparison plugin according to a preset comparison rule, and sorting the candidate to-be-preempted nodes according to a comparison result of the any two candidate to-be-preempted nodes.

17. The electronic device according to claim 16, wherein comparing any two candidate to-be-preempted nodes in the preset comparison plugin according to the preset comparison rule comprises:
obtaining scores of the any two candidate to-be-preempted nodes separately in the preset comparison plugin according to the preset comparison rule, and comparing the any two candidate to-be-preempted nodes based on the scores, wherein a score of any candidate to-be-preempted node is used to evaluate suitability of the any candidate to-be-preempted node being preempted.

18. The electronic device according to claim 16, further comprising:
setting a preset comparison rule of the preset comparison plugin in response to a preset comparison rule setting instruction, wherein the preset comparison rule is a comparison rule associated with the preset judgment rule in the target judgment rule plugin.

19. A non-transitory computer-readable storage medium, storing computer-executable instructions which, when executed by a processor, implement a method comprising:
determining, in response to a rule plugin selection instruction, a target judgment rule plugin from a plurality of preset judgment rule plugins comprised in a preset judgment rule plugin set, and loading the target judgment rule plugin into a scheduler of the cloud native orchestration and scheduling system, wherein each judgment rule plugin is configured with at least one preset judgment rule for judging whether an instance is allowed to be preempted;
sequentially judging, by using the target judgment rule plugin and for a to-be-deployed instance, whether any instance on any node in the cloud native orchestration and scheduling system is allowed to be preempted by the to-be-deployed instance;
if there is an instance allowed to be preempted by the to-be-deployed instance on the any node, determining the any node as a candidate to-be-preempted node, and determining a candidate to-be-preempted instance on the candidate to-be-preempted node according to the to-be-deployed instance and the instance allowed to be preempted on the candidate to-be-preempted node; and
sorting candidate to-be-preempted nodes by using a preset comparison plugin in the scheduler, determining a target to-be-preempted node according to a sorting result, and controlling the to-be-deployed instance to preempt the candidate to-be-preempted instance on the target to-be-preempted node.

20. The non-transitory computer-readable storage medium according to claim 19, wherein the sequentially judging, by using the target judgment rule plugin, whether the any instance on the any node in the cloud native orchestration and scheduling system is allowed to be preempted by the to-be-deployed instance comprises:
acquiring input information of the target judgment rule plugin, wherein the input information comprises one or more of: information about the to-be-deployed instance, information about the any node, or information about the any instance; and
inputting the input information into the target judgment rule plugin, and judging, by using a preset judgment rule in the target judgment rule plugin, whether the any instance is allowed to be preempted by the to-be-deployed instance.
